(19) United States
(12) Patent Application Publication
(10) Pub. No.: US 2014/0019541 A1
(43) Pub. Date: Jan. 16, 2014

(54) SYSTEMS AND METHODS FOR SELECTING CONTENT USING WEBREF ENTITIES

(71) Applicants: Yuan Zhou, Shanghai (CN); Gaofeng Zhao, Santa Clara, CA (US); Zhen Yu, Shanghai (CN); Claire Cui, Palo Alto, CA (US)

(72) Inventors: Yuan Zhou, Shanghai (CN); Gaofeng Zhao, Santa Clara, CA (US); Zhen Yu, Shanghai (CN); Claire Cui, Palo Alto, CA (US)

(21) Appl. No.: 13/739,734

(22) Filed: Jan. 11, 2013

Related U.S. Application Data
(63) Continuation of application No. PCT/CN2012/078569, filed on Jul. 12, 2012.

(51) Int. Cl. H04L 29/08

(52) U.S. Cl. CPC H04L 67/02
USPC 709/204

(57) ABSTRACT

Systems and methods for providing content via a computer network using reference entities that can increase accuracy and minimize ambiguity of information used in online content selection are provided. A data processing system obtains a classification of a plurality of entities. Responsive to receiving a request for content for a user of a web page, the data processing system identifies an entity of the web page. The entity can include metadata about the classification. The data processing system matches the entity with content in a content repository to select content eligible for display on the web page.

### CROSS-REFERENCES TO RELATED APPLICATIONS

This application claims priority to PCT Application No. PCT/CN2012/078569, titled “Systems and Methods for Selecting Content Using Webref Entities,” and filed on Jul. 12, 2012, the entirety of which is hereby incorporated by reference.

### BACKGROUND

In a networked environment such as the internet, entities such as people or companies provide information for public display on web pages. The web pages can include text, video, or audio information provided by the entities via a web page server for display on the internet. Additional content such as advertisements can also be provided by third parties for display on the web pages together with the information provided by the entities. Thus, a person viewing a web page can access the information that is the subject of the web page, as well as third party advertisements that may appear with the web page.

### SUMMARY

At least one aspect is directed to a computer implemented method of providing content via a computer network. The method can include a data processing system obtaining a classification of a plurality of entities, and receiving a request for content for a user of a web page. The method can include identifying an entity of the web page, and the entity can include a unique identifier that identifies an entity classification. The method can include matching the entity with content in a content repository based at least in part on the entity classification to select content eligible for display on the web page.

At least one aspect is directed to a system of providing content via a computer network. The system can include a data processing system having at least one of an entity identification circuit, a matching circuit and a content repository. The data processing system can obtain a manual classification of a plurality of entities. The data processing system can receive a request for content for a user of a web page. The data processing system can identify an entity of the web page. The entity can include a unique identifier that identifies an entity classification. The data processing system can match the entity with content in the content repository based at least in part on the entity classification to select content eligible for display on the web page.

At least one aspect is directed to a computer readable storage medium having instructions to provide content via a computer network. The instructions can include instructions to obtain a manual classification of a plurality of entities. The instructions can include instructions to receive a request for content for a user of a web page, and to identify an entity of the web page. The entity can include a unique identifier that identifies an entity classification. The instructions can include instructions to match the entity with a plurality of content to select content based at least in part on the entity classification eligible for display on the web page.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is an illustration of an example system for selecting content of a computer network in accordance with an implementation.

FIG. 2 is a flow chart illustrating an example method for selecting content of a computer network in accordance with an implementation.

FIG. 3 is a flow chart illustrating example methods for selecting content of a computer network in accordance with some implementations.

FIG. 4 shows an illustration of an example network environment comprising client machines in communication with remote machines in accordance with an implementation.

FIG. 5 is a block diagram illustrating a general architecture for a computer system that may be employed to implement various elements of the system shown in FIG. 1 and the method shown in FIG. 2, in accordance with an implementation.

Like reference numbers and designations in the various drawings indicate like elements.

### DETAILED DESCRIPTION

Some implementations of the disclosure are directed to systems and methods of providing content using web reference (“webref”) entities that increase accuracy and minimize ambiguity of information used in online content selection. Web reference entities assist in the understanding of text and augment a repository of knowledge. An entity may be a single person, place or thing, and the repository can include millions of entities that each have a unique identifier to distinguish among multiple entities with similar names (e.g., a Jaguar car versus a jaguar animal). A data processing system can access a reference entity and scan arbitrary pieces of text (e.g., text in web pages, text of keywords, text of content, text of advertisements) to identify entities from various sources. One such source, for example, may be a manually created taxonomy of entities such as an entity graph of people, places and things, built by a community of users.

A data processing system may use webref entities to select content in multiple ways. For example, the data processing system can determine an entity of a web page by extracting a webref entity from a web page or a keyword of the web page. The data processing system may match the entity of the web page with the entity of a keyword of the web page to increase the score of the keyword. During content selection, the data processing system may be more likely to identify or select content (such as an advertisement) associated with higher scoring keywords. For example, the data processing system may determine that a web page contains the entity “automobile”. The data processing system may also determine that the web page contains four keywords “car”, “used car”, “new car”, “bicycle”. The data processing may determine that of the four keywords, three keywords (“car”, “used car”, “new car”) contain the entity “automobile”. The data processing system may assign or modify the keyword score of the three keywords that contain the same entity as the web page and use the higher scoring keywords to select content for display with the web page. In some implementations, content providers (e.g., advertisers) may bid on webref entities to increase the likelihood that their content will be selected for display on a web page that includes the entity.

In some implementations, the data processing system selects content by matching the entity of the web page with the entity of content. For example, the data processing system may determine an entity of content (e.g., an advertisement) based on input from a content provider. The data processing system may then match an entity of the web page with an entity of content to select or score content. For example, for a web page with the entity automobile, the data processing system may be more likely to retrieve or assign a high score to advertisements that also have the entity automobile, such as advertisements for selling cars.

In an illustrative example, a content provider can provide content such as an advertisement to a data processing system. The data processing system can parse terms of the content to determine one or more entities. The data processing system may prompt the content provider with a query for the content provider to indicate one or more entities of a subset of entities that the content provider considers relevant to the content. At content serving time (e.g., when the data processing system is in the process of identifying content to provide for display with an information resource such as a web page), the data processing system may evaluate webref or other reference entity to label the entities of a web page requesting an advertisement for display to a user. For example, the data processing system may map the phrases in the document to well defined entities in a database. The data processing system may score the entities based on the relations among entities in the database and select the entities with the highest weight as page entities. For example, the entity about Jaguar cars may be related to entities “Jaguar C-X75”, “SS 90”, “Jaguar XJR-15” while the entity about animal Jaguar may be related to entities “Paseo de Jaguar”, “Maya jaguar gods”, “Gabi (Dog)”. If a page includes the term Jaguar, the entity about Jaguar cars may receive a higher score if related entities about cars are present. In another example, if a web page includes the term Jaguar, the entity about Jaguar animal may receive a higher score if related entities about animals are present.

The data processing system can score the entities of the web page to determine the main entities of the web page (e.g., entities having the highest score), and use the main entities to retrieve content such as advertisements that can be provided for display with a rendering of a web page on a user device. For example, the data processing system may match the main entities of the web page with entities of advertisements to select a matching advertisement or assign a score to a matching advertisement. In another example, the data processing system may determine placement criteria (e.g., keywords, terms, semantic topics or concepts, or content verticals) based on the entities of the web page or advertisements to identify a matching advertisement or assign a score to a matching advertisement. In yet another example, the content provider may instruct that a web page contain one or more entities in order for the web page to be eligible to receive the content provider's advertisement. The data processing system can retrieve multiple content matches or identify multiple items of eligible content, in which case the data processing system may score or rank the content to select one or more content items (e.g., advertisements) to provide for display on the web page. The score may be based in part on the number of matching entities or placement criteria associated with the entities.

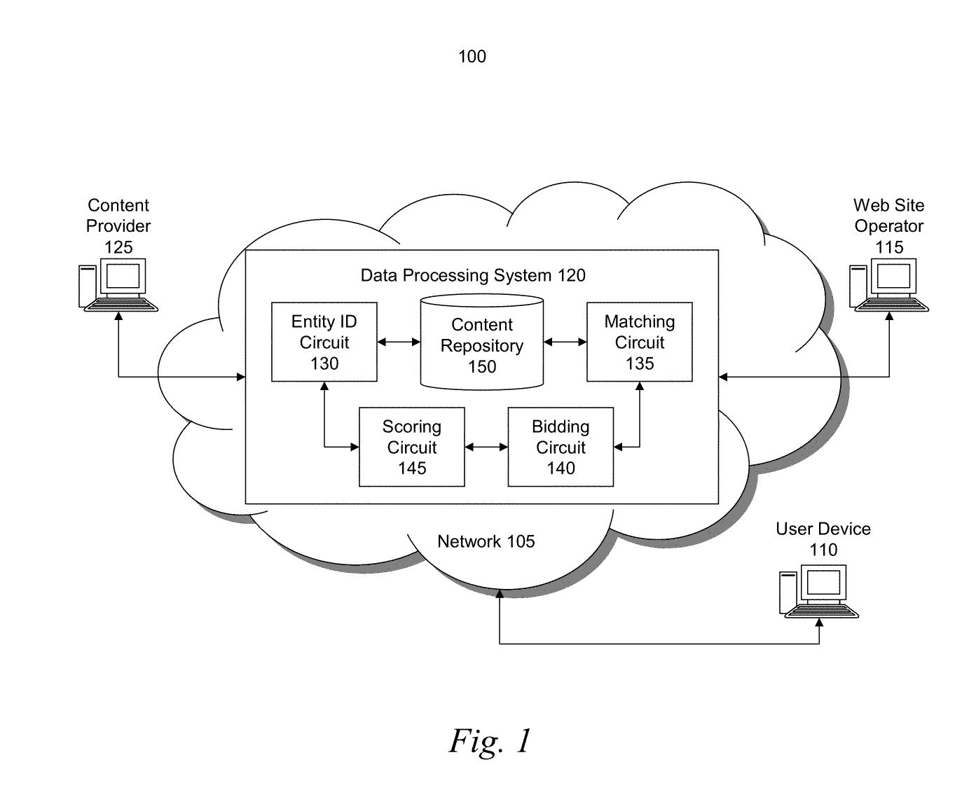

FIG. 1 illustrates an example system 100 of selecting content via a computer network such as network 105. The network 105 can include computer networks such as the Internet, local, wide, metro, or other area networks, intranets, satellite networks, and other communication networks such as voice or data mobile telephone networks. The network 105 can be used to access information resources such as web pages, web sites, domain names, or uniform resource locators that can be displayed on at least one user device 110, such as a laptop, desktop, tablet, personal digital assistant, smart phone, or portable computers. For example, via the network 105 a user of the user device 110 can access web pages provided by at least one web site operator 115. In this example, a web browser of the user device 110 can access a web server of the web site operator 115 to retrieve a web page for display on a monitor of the user device 110. The web site operator 115 generally includes an entity that operates the web page. In one implementation, the web site operator 115 includes at least one web page server that communicates with the network 105 to make the web page available to the user device 110.

The user of a user device 110 may opt out of one or more aspect of the present disclosure. For example, the user may opt out of allowing the data processing system 120 to provide content for display on the user device 110. The user may also opt out of allowing the data processing system 120 to select content for display on the user device using entities to select content or select content in some other way. In some implementations, the data processing system 120 may prompt the user of the user device 110 for permission to select or provide content for display on the user device 110 or for the user to otherwise opt in to one or more aspect of the present disclosure. In some implementations, the user of the user device 110 is anonymous, e.g., no personally identifiable information is used or acquired by the data processing system 120 to perform one or more aspect of the present disclosure. For example, the data processing system may use an anonymous device identifier.

The system 100 can include at least one data processing system 120. The data processing system 120 can include at least one logic device such as a computing device having a processor to communicate via the network 105, for example with the user device 110, the web site operator 115, and at least one content provider 125. The data processing system 120 can include at least one server. For example, the data processing system 120 can include a plurality of servers located in at least one data center. In one implementation, the data processing system 120 includes a content placement system having at least one server. The data processing system 120 can also include at least one entity identification circuit 130, at least one matching circuit 135, at least one bidding circuit 140, at least one scoring circuit 145 and at least one content repository 150. The entity identification circuit 130, matching circuit 135, bidding circuit 140, and scoring circuit 145 can each include at least one processing unit or other logic device such as programmable logic arrays, application specific integrated circuit, engines, or modules configured to communicate with the content repository 150. The content repository 150 may include a database. The entity identification circuit 130, matching circuit 135, bidding circuit 140, and scoring circuit 145 can be separate components, a single component, or an engine or module having at least one logic device (e.g., a processor) part of the data processing system 120.

In some implementations, the data processing system 120 obtains a classification of a plurality of entities. An entity may be a single person, place, thing or topic. Each entity has a unique identifier that may distinguish among multiple entities with similar names (e.g., a Jaguar car versus a jaguar animal). A unique identifier (“ID”) may be a combination of characters, text, numbers, or symbols. The data processing system may obtain the classification from an internal or third-party database via network 105. In one implementation, the entities may be manually classified by users of a user device 110. For example, users may access the database of entities via network 105. Users may upload at least one entity or upload multiple entities in a bulk upload. Users may classify the uploaded entities, or the upload may include the classification of at least one entity. In some implementations, upon receiving an entity, the data processing system 120 may prompt the user for a classification.

In some implementations, entities may be manually classified by users. Classifications may indicate the manner in which entities are categorized or structured, e.g., ontology. For example, an ontological classification may include attributes, aspects, properties, features, characteristics, or parameters that entities can have. Ontological classifications may also include classes, sets, collections, concepts, or types. For example, an ontology of “vehicle” may include: type—ground vehicle, ship, air craft; function—to carry persons, to carry freights; attribute—power, size; component—engine, body; etc. In some implementations, the manual classification includes structured data that provides a manually created taxonomy of entities. Entities may be associated with an entity type, such as people, places, books, or films, for example. Entity types may include additional properties, such as date of birth for a person or latitude and longitude for a location, for example. Entities may also be associated with domains, such as a collection of types that share a namespace, which includes a directory of uniquely named objects (e.g., domain names on the internet, paths in a uniform resource locator, or directors in a computer file system). Entities may also include metadata that describes properties (or paths formed through the use of multiple properties) in terms of general relationships.

The data processing system 120 or a user of user device 110 may classify an entity based on a domain, type, and property. For example, a domain may be American football and have an ID “/american_football”. This domain may be associated with a head coach type with ID “/American_football/football_coach”. This type may include a property for current team head coached with ID “/American_football/football_coach/current_team_head_coached”. Each domain, type, property or other category may include a description. For example, “/American_football/football_coach” may include the following description: “‘Football Coach’ refers to coaches of the American sport Football.” In some implementations, the data processing system 120 can scan text or other data of a document and automatically determine a classification. For example, the data processing system 120 may scan information resources via network 105 for information about football coaches, and classify that information as “/American_football/football_coach”. The data processing system 120 may further assign the entity football coach a unique identifier that indicates a classification.

Entities may be classified, at least in part, by one or more humans (“entity contributors”). This may be referred to as manual classification. In some implementations, entities may be classified using crowd sourcing processes. Crowd sourcing may occur online or offline and may refer to a process that involves outsourcing tasks to a defined group of people, distributed group of people, or undefined group of people. An example of online crowd sourcing may include a web site operator 115 assigning the task of uploading or classifying entities to an undefined set of users of user devices 110. Users may add, modify, or delete classifications online. An example of offline crowd sourcing may include assigning the task of uploading or classifying entities to an undefined public not using the network 105, e.g., to students in a classroom or passersby on the street or at a mall.

In some implementations, data processing system 120 may obtain or gain access to the classification of a plurality entities from content repository 150 (e.g., a content repository) or another database accessible via network 105. In some implementations, entities may be stored in a graph database where the entity data structure includes as a set of nodes and a set of links that establish relationships between the nodes. The entity data structure in the graph database may be non-hierarchical, which may facilitate modeling complex relationships between individual elements, and allow entity contributors to enter new objects and relationships into the underlying graph structure.

In some implementations, the data processing system 120 receives a request for content for a user of a web page. For example, the data processing system 120 may receive the request from a web site operator 115 via network 105. The web site operator 115 may transmit the request for content in response to a user of user device 110 requesting access to a web page of the web site operator 115. The request may include information that facilitates content selection. In some implementations, the request includes information about the web page (e.g., URL, text, metadata, or placement criteria such as keywords) or at least one entity of the web page. The request can also include information about the properties of the content slot for which content is requested, including, e.g., size or position.

In some implementations, the data processing system 120 identifies an entity of the web page. For example, the data processing system 120 includes a web reference circuit that determines an entity of the web page. The data processing system may map the phrases in the document to well defined entities in a database. The data processing system may score the entities based on the relations among entities in the database and select the entities with the highest weight as page entities.

The identified entities can include additional information about the classification (e.g., metadata). The additional information may include a domain, type, property, or description, for example. In some implementation, the entity includes a unique identifier that indicates a classification of the entity. The additional information may be inferred via the unique identifier of the entity. For example, an entity may be French, with a unique identifier “/dining/cuisine”. The unique identifier “/dining/cuisine” may include, for example, properties such as description, region of origin, restaurants, ingredients, dishes, or chefs.

In some implementations, the data processing system 120 matches the entity with content in a content repository. For example, using the entity classification, the data processing system 120 can identify a correlation between the entity and the content to select content eligible for display on the web page. The content may include text, images, multimedia, advertisements, or articles, for example. A content repository can be part of the content repository 150 or another database accessible via network 105. In some implementations, the content is provided by content provider 125. Information about the content may also be provided by the content provider 125 and stored in content repository 150.

The data processing system 120 can provide a prompt to content provider 125. The prompt may include a query requesting information from the content provider 125. In some implementations, the data processing system 120 provides a prompt upon, or responsive to, the receipt of information about the content, such as placement criteria. Placement criteria may include keywords, terms, semantic concepts or topics, or additional content. The prompt may be provided offline, e.g., prior to content serving time. For example, the prompt may be provided when the content provider 125 uploads content to data processing system 120, uploads information or a URL for the content, or modifies information about the content. The prompt may be for additional information related to the content, including, e.g., entity information, entity classification information, or the unique identifier of an entity. In some implementations, the prompt may be for information that facilitates determining an entity or entity classification associated with the content.

In some implementations, the data processing system 120 determines that information about the content is ambiguous, and, responsive to this determination, prompts the content provider 125 or another entity for information related to the content. For example, the term “football” may refer to American football, Australian football, or soccer; the term “park” may refer to a playground, ballpark, amusement park, or a parking lot. In some implementations, the prompt may include multiple possible classifications or unique identifiers for the information or placement criteria. For keyword “football” the prompt may include “/American_football” and “/soccer”, for example.

The data processing system 120 may receive information from the content provider 125, via a user interface, that is responsive to the prompt. The user interface may include buttons, drop down menu, search fields, input text fields, or another way of selecting or searching for entity or classification information. The content provider 125 may select from choices provided by the prompt, or may provide additional information that disambiguates the placement criteria. In some implementations, the data processing system 120 obtains a response to the prompt and stores the response in the content repository 150 or otherwise associates the response to the prompt with content. For example, the content repository 150 may store the entity classification provided by the content provider 125 for the content or the placement criteria associated with the content.

The data processing system 120 can select content eligible for display by matching an entity with content, such as an advertisement. For example, the matching circuit 135 can match an entity with the content. In some implementations, the data processing system 120 matches at least one entity (e.g., a first entity) of a web page with at least one entity of content (e.g., a second entity). For example, the data processing system 120 may determine that a web page includes the entity “park” and determine, based on the entity classification, that park relates to amusement parks. The data processing system 120 may then match content that contains the entity amusement parks, such as advertisements for a theme park, theme park ticket discounts, or vacation packages. In some implementations, the data processing system 120 obtains at least two entities of content to match entities of a web page in order for the content to be eligible for display with the web page on the user device 110.

In some implementations, the data processing system 120 determines placement criteria of an entity and matches the placement criteria with at least one entity of content. The placement criteria of an entity may include, e.g., keywords, terms, text, semantic concepts or topics. The data processing system 120 can determine placement criteria of an entity based on the entity classification or other categorization. With reference to the French cuisine example described above, the data processing system 120 may determine additional placement criteria based on entity types or properties, such as restaurants, ingredients, or dishes. For example, keywords of entity French cuisine may be baguette, foie gras, or éclair.

The data processing system 120 may match placement criteria of an entity with placement criteria of content. For example, the data processing system 120 may expand at least one entity of a web page to determine placement criteria (e.g., keywords) and also expand at least one entity of content in the content repository to determine placement criteria. The data processing system 120 can match keywords of the web page with keywords of the content to identify matching content. In some implementations, keywords assigned a higher score are more likely to be used by the matching circuit 135 to identify or retrieve matching content. Referring again to the French cuisine example, the data processing system 120 may identify an advertisement or other content that includes at least one keyword baguette, foie gras, and éclair.

The data processing system 120 may score or rank entities or content associated with entities in multiple ways. In some implementations, that data processing 120 or a component thereof such as the scoring circuit 145 assigns a higher score to keywords of a web page that are associated with an entity of the web page. For example, an entity of the web page may be associated with an entity of a keyword of the web page. Matching the entity of a keyword of a web page with the entity of a web page may indicate that the keyword of the web page is more relevant to the web page. In some implementations, the data processing system 120 ranks content associated with the entity of the web paged based on the score of the entity. For example, content associated with a top scoring entity may be ranked higher than content associated with lower scoring entities. Higher ranked content may be more likely to be selected for display with the web page.

In some implementations, the data processing system 120 ranks multiple entities of a web page or content based on estimated performance. For example, the data processing system 120 may score based on an estimated performance, such as a click through rate, conversion rate, or predicted click through rate, for example. The estimated performance may be specific to the web page, to the entity, or content. The estimated performance may be based on historic user interaction with a web page, content of the web page, or entities associated with the web page or content. Higher performing entities may be used for content selection. For example, a web page may include three entities “automobile”, “insurance”, and “books”. In this example, the data processing system 120 may determine that the entity automobile is the highest performing entity because content associated with that entity has the highest click through rate or conversion rate for the web page.

In some implementations, the data processing system 120 scores an entity based on a bid. The bid, or bid value, generally indicates a monetary amount that the content provider 125 agrees to pay to have their content provided for display with a web page or other information resource. In some implementation, the data processing system 120 includes a bidding circuit 140 that scores an entity based on a bid. The data processing system 120 may receive a bid on an entity and evaluate the bid to determine the score of the entity. The bid may be received from a content provider 125 via the network 105. The bid may be a monetary bid or be based on a points system. The data processing system 120 may evaluate the bid based on the amount of the bid. For example, a higher bid increases the likelihood that content of a content provider 125 will be selected by the data processing system 120. For example, multiple content items of multiple content providers 125 may be eligible for display with a web page by matching a first entity of a web page. That is, each matching content contains the first entity. In this example, a first content provider 125 may bid $1 on the first entity, a second content provider 125 may bid $2 on a second entity, and a third content provider may bid $3 on the first entity. The content associated with the highest bid for the matching entity may be selected for display with the web page. Content of the third content provider may be selected by the data processing system 120 for display with the web page.

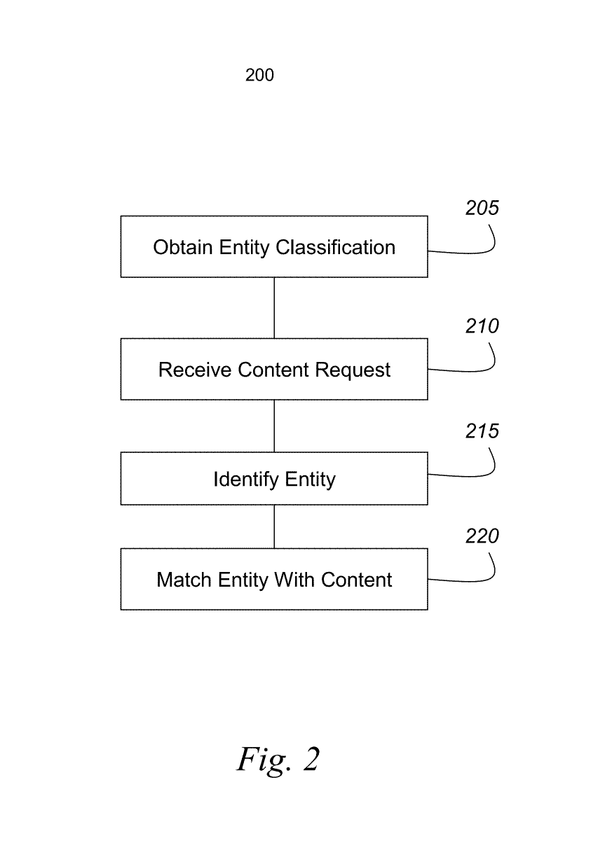

FIG. 2 is a flow chart illustrating an example method 200 for selecting content of a computer network in accordance with an implementation. In one implementation, the method 200 obtains access to a classification such as a manual classification of multiple entities (BLOCK 205). For example, the data processing system may obtain the classification from a database via a network. In some implementations, the method 200 includes accessing or gaining access to the manual classification. The classification may be updated in real-time by users of a network.

In some implementations, the method 200 receives a request for content for a user of a web page (BLOCK 210). For example, the data processing system may receive the request (BLOCK 210) from a user of a user device via a network. The request may include information that can facilitate content selection, such as information about the web page or content slot of the web page. Content slot information may include size or position. Information about the web page may include metadata or keywords of the web page.

In some implementations, the method 200 identifies a reference entity such as a webref entity of the web page (BLOCK 215). For example, the data processing system may parse text or metadata of the web page to determine one or more webref entity of the web page. The webref entity may include a unique identifier that identifies an entity classification.

In some implementations, the method 200 matches an entity of a web page with content to select content eligible for display on the web page (BLOCK 220). For example, based at least in part on the entity classification, the data processing system can match the entity of the web page with the entity of content in a content repository. In some implementations, the method 200 matches placement criteria of the entity of the web page with placement criteria of content of a content repository. For example, the method 200 may identify an entity of a web page and determine a keyword associated with the entity of the web page. The method 200 may then identify content of a content repository that is associated with the keyword.

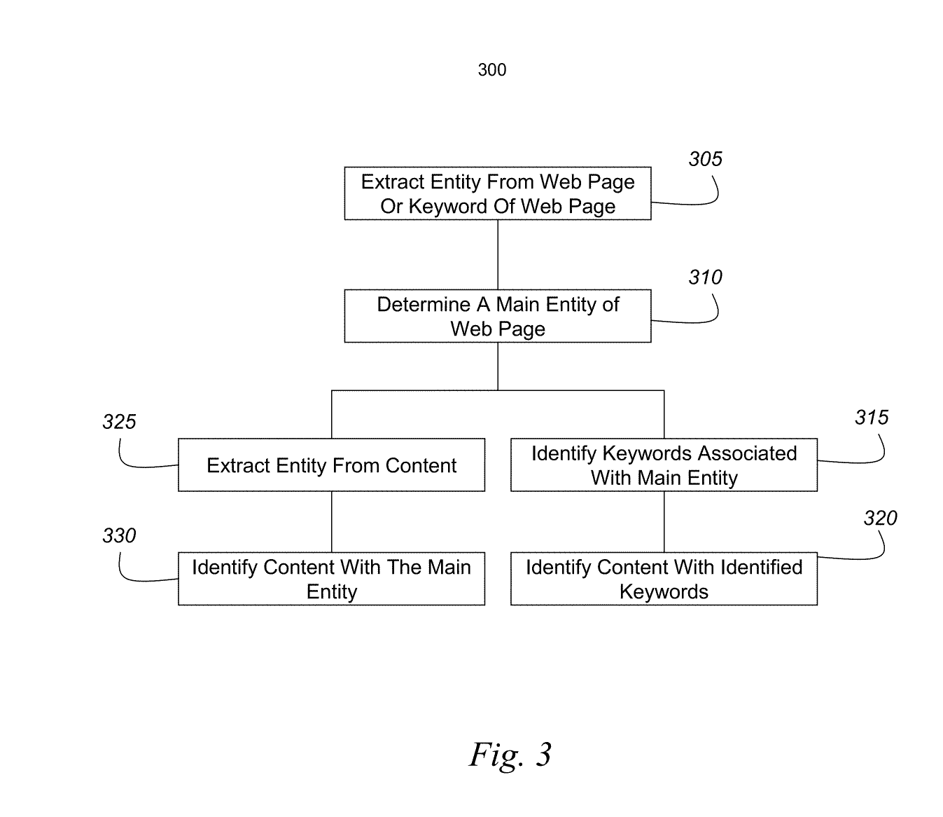

FIG. 3 is a flow chart illustrating example methods for selecting content of a computer network in accordance with some implementations. In some implementations, the method 300 extracts an entity from a web page or other information resource (BLOCK 305). For example, the data processing system can extract the entity from the web page by selecting a keyword of a web page and extracting an entity of the keyword (BLOCK 305).

In some implementations, the method 300 determines a main entity of the web page (BLOCK 310). For example, the main entity of the web page can be determined based on the number of keywords of the web page that are associated with the entity. For example, if a web page includes 10 keywords and 6 of them are associated with the first entity, then the method 300 may identify the first entity as the main entity.

In some implementations, the method 300 identifies keywords associated with the main entity (BLOCK 315). For example, the data processing system can identify keywords of the main entity based on the manual classification of entities stored in a database. The classification may indicate multiple terms associated with the main entity. For example, for the entity automobile, the classification may include sub-classes luxury cars, sports cars, compact cars, car manufacturers, country of origin, etc. The class description or value may be used as keywords. In some implementations, the method 300 identifies content with the identified keywords (BLOCK 320). The identified content may be eligible for display on a web page.

In some implementations, the method 300 extracts an entity from content in a content repository (BLOCK 325). The content in the content repository may be associated with an entity, which may have a unique identifier indicating an entity classification. In some implementations, a content provider may indicate an entity of content stored in the content repository. In some implementations, the method 300 identifies the content with the main entity (BLOCK 330).

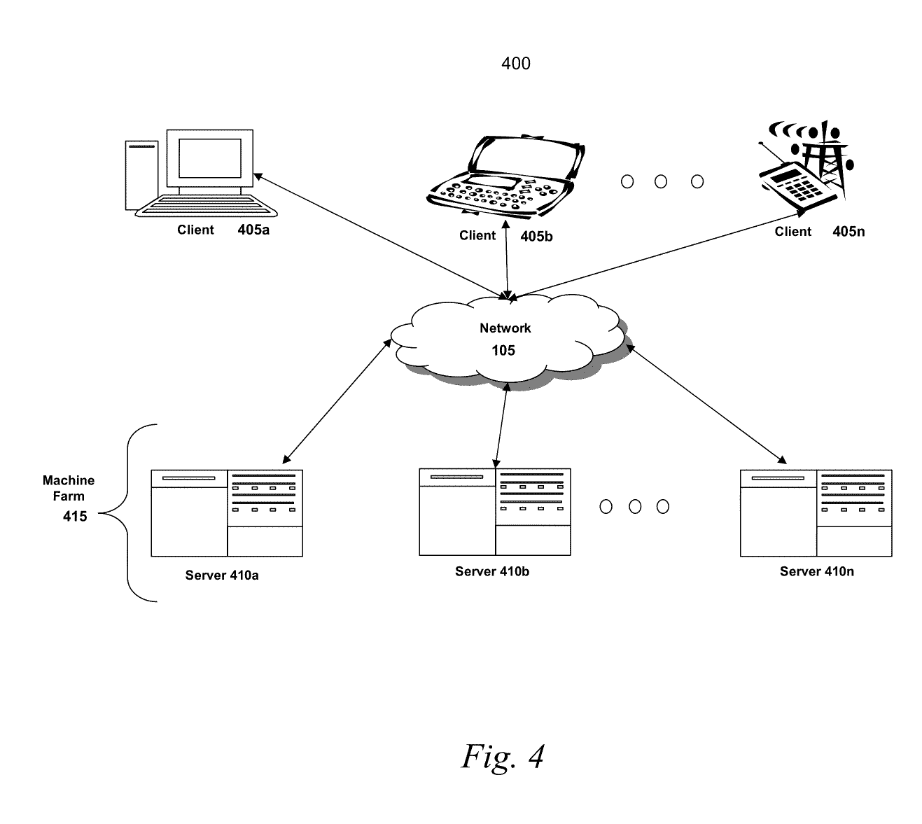

The system 100 and its components, such as a data processing system, may include hardware elements, such as one or more processors, logic devices, or circuits. FIG. 4 is an example implementation of a network environment 400. The system 100 and method 200 can operate in the network environment 400 depicted in FIG. 4. In brief overview, the network environment 400 includes one or more clients 405 that can be referred to as local machine(s) 405, client(s) 405, client node(s) 405, client machine(s) 405, client computer(s) 405, client device(s) 405, endpoint(s) 405, or endpoint node(s) 405) in communication with one or more servers 410 that can be referred to as server(s) 410, node 410, or remote machine(s) 410) via one or more networks 105. In some implementations, a client 405 has the capacity to function as both a client node seeking access to resources provided by a server and as a server providing access to hosted resources for other clients 405.

Although FIG. 4 shows a network 105 between the clients 405 and the servers 410, the clients 405 and the servers 410 may be on the same network 105. The network 105 can be a local-area network (LAN), such as a company Intranet, a metropolitan area network (MAN), or a wide area network (WAN), such as the Internet or the World Wide Web. In some implementations, there are multiple networks 105 between the clients 105 and the servers 410. In one of these implementations, the network 105 may be a public network, a private network, or may include combinations of public and private networks.

The network 105 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, the network 105 may include a wireless link, such as an infrared channel or satellite band. The topology of the network 105 may include a bus, star, or ring network topology. The network may include mobile telephone networks utilizing any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). In some implementations, different types of data may be transmitted via different protocols. In other implementations, the same types of data may be transmitted via different protocols.

In some implementations, the system 100 may include multiple, logically-grouped servers 410. In one of these implementations, the logical group of servers may be referred to as a server farm 415 or a machine farm 415. In another of these implementations, the servers 410 may be geographically dispersed. In other implementations, a machine farm 415 may be administered as a single entity. In still other implementations, the machine farm 415 includes a plurality of machine farms 415. The servers 410 within each machine farm 415 can be heterogeneous—one or more of the servers 410 or machines 410 can operate according to one type of operating system platform.

In one implementation, servers 410 in the machine farm 415 may be stored in high-density rack systems, along with associated storage systems, and located in an enterprise data center. In this implementation, consolidating the servers 410 in this way may improve system manageability, data security, the physical security of the system, and system performance by locating servers 410 and high performance storage systems on localized high performance networks. Centralizing the servers 410 and storage systems and coupling them with advanced system management tools allows more efficient use of server resources.

The servers 410 of each machine farm 415 do not need to be physically proximate to another server 410 in the same machine farm 415. Thus, the group of servers 410 logically grouped as a machine farm 415 may be interconnected using a wide-area network (WAN) connection or a metropolitan-area network (MAN) connection. For example, a machine farm 415 may include servers 410 physically located in different continents or different regions of a continent, country, state, city, campus, or room. Data transmission speeds between servers 410 in the machine farm 415 can be increased if the servers 410 are connected using a local-area network (LAN) connection or some form of direct connection. Additionally, a heterogeneous machine farm 415 may include one or more servers 410 operating according to a type of operating system, while one or more other servers 410 execute one or more types of hypervisors rather than operating systems. In these implementations, hypervisors may be used to emulate virtual hardware, partition physical hardware, virtualize physical hardware, and execute virtual machines that provide access to computing environments.

Management of the machine farm 415 may be de-centralized. For example, one or more servers 410 may comprise components, subsystems and circuits to support one or more management services for the machine farm 415. In one of these implementations, one or more servers 410 provide functionality for management of dynamic data, including techniques for handling failover, data replication, and increasing the robustness of the machine farm 415. Each server 410 may communicate with a persistent store and, in some implementations, with a dynamic store.

Server 410 may include a file server, application server, web server, proxy server, appliance, network appliance, gateway, gateway, gateway server, virtualization server, deployment server, secure sockets layer virtual private network (“SSL VPN”) server, or firewall. In one implementation, the server 410 may be referred to as a remote machine or a node.

The client 405 and server 410 may be deployed as or executed on any type and form of computing device, such as a computer, network device or appliance capable of communicating on any type and form of network and performing the operations described herein.

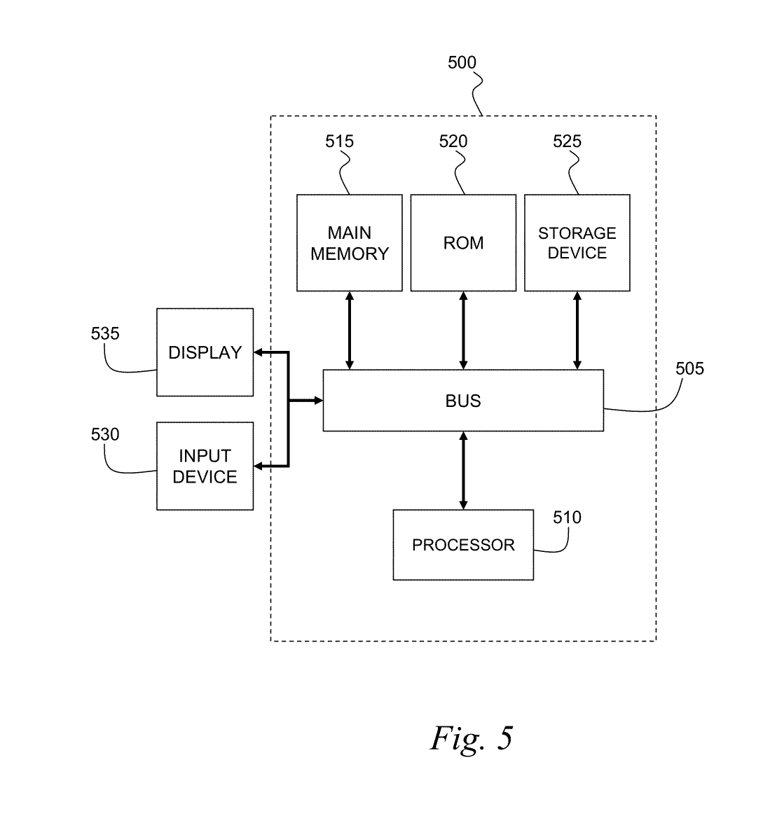

FIG. 5 is a block diagram of a computer system 500 in accordance with an illustrative implementation. The computer system or computing device 500 can be used to implement the system 100, content provider 125, user device 110, web site operator 115, data processing system 120, weighting circuit 130, content selector circuit 135, and content repository 150. The computing system 500 includes a bus 505 or other communication component for communicating information and a processor 510 or processing circuit coupled to the bus 505 for processing information. The computing system 500 can also include one or more processors 510 or processing circuits coupled to the bus for processing information. The computing system 500 also includes main memory 515, such as a random access memory (RAM) or other dynamic storage device, coupled to the bus 505 for storing information, and instructions to be executed by the processor 510. Main memory 515 can also be used for storing position information, temporary variables, or other intermediate information during execution of instructions by the processor 510. The computing system 500 may further include a read only memory (ROM) 520 or other static storage device coupled to the bus 505 for storing static information and instructions for the processor 510. A storage device 525, such as a solid state device, magnetic disk or optical disk, is coupled to the bus 505 for persistently storing information and instructions.

The computing system 500 may be coupled via the bus 505 to a display 535, such as a liquid crystal display, or active matrix display, for displaying information to a user. An input device 530, such as a keyboard including alphanumeric and other keys, may be coupled to the bus 505 for communicating information and command selections to the processor 510. In another implementation, the input device 530 has a touch screen display 535. The input device 530 can include a cursor control, such as a mouse, a trackball, or cursor direction keys, for communicating direction information and command selections to the processor 510 and for controlling cursor movement on the display 535.

According to various implementations, the processes described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to effect illustrative implementations. Thus, implementations are not limited to any specific combination of hardware circuitry and software.

Although an example computing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, i.e., one or more circuits of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is tangible.

The operations described in this specification can be performed by a data processing apparatus on data stored on one or more computer-readable storage devices or received from other sources.

The term “data processing apparatus” or “computing device” encompasses various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a circuit, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more circuits, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer implemented method of providing content via a computer network, comprising:
obtaining, by a data processing system, a classification of a plurality of entities;
receiving, by the data processing system, a request for content for a user of a web page;
identifying, by the data processing system, an entity of the web page, wherein the entity includes a unique identifier that identifies an entity classification; and
matching the entity with content in a content repository based at least in part on the entity classification to select content eligible for display on the web page.

2. The method of claim 1, further comprising:
receiving the content in the content repository from a content provider;
providing a prompt for additional information related to the content; and
receiving a response to the prompt.

3. The method of claim 2, wherein the content in the content repository includes the response.

4. The method of claim 1, wherein the classification includes a manual classification that comprises structured data that provides a manually created taxonomy of entities.

5. The method of claim 1, wherein matching the entity with content in the content repository further comprises:
determining placement criteria associated with the entity; and
matching the placement criteria with content in a content repository.

6. The method of claim 1, wherein the entity is a first entity and matching the entity with the content in the content repository further comprises:
determining, for the content in the content repository, a second entity; and
matching the first entity with the second entity.

7. The method of claim 1, wherein the entity includes a keyword of the web page.

8. The method of claim 1, further comprising:
ranking the plurality of entities based on estimated performance of the plurality of entities.

9. The method of claim 1, further comprising:
determining a score of the entity of the web page; and
ranking content associated with the entity of the web page based on the score of the entity.

10. The method of claim 9, further comprising:
receiving, by the data processing system, a bid on the entity; and
evaluating the bid to determine the score of the entity.

11. A system for providing content via a computer network, comprising:
a data processing system having at least one of an entity identification circuit, a matching circuit and a content repository, the data processing system configured to:
obtain a manual classification of a plurality of entities;
receive a request for content for a user of a web page;
identify an entity of the web page, wherein the entity includes a unique identifier that identifies an entity classification; and
match the entity with content in the content repository based at least in part on the entity classification to select content eligible for display on the web page.

12. The system of claim 11, wherein the data processing system is further configured to:
receive the content in the content repository from a content provider;
provide a prompt for additional information related to the content; and
receive a response to the prompt.

13. The system of claim 12, wherein the content in the content repository includes the response.

14. The system of claim 11, wherein the manual classification comprises structured data that provides a manually created taxonomy of entities.

15. The system of claim 11, wherein the data processing is further configured to:
determine placement criteria associated with the entity; and
match the placement criteria with content in a content repository.

16. The system of claim 11, wherein the entity is a first entity and the data processing system is further configured to:
determine, for the content in the content repository, a second entity; and
match the first entity with the second entity.

17. The system of claim 11, wherein the data processing system is further configured to:
determine a score of the entity of the web page; and
rank content associated with the entity of the web page based on the score of the entity.

18. The system of claim 17, wherein the data processing system is further configured to:
receive a bid on the entity; and
evaluate the bid to determine the score of the entity.

19. A computer readable storage medium having instructions to provide content via a computer network, the instructions comprising instructions to:
obtain a manual classification of a plurality of entities;
receive a request for content for a user of a web page;
identify an entity of the web page, wherein the entity includes a unique identifier that identifies an entity classification; and
match the entity with a plurality of content based at least in part on the entity classification to select content eligible for display on the web page.

20. The computer readable storage medium of claim 19, wherein the instructions further comprise instructions to:
receive the content of the plurality of content from a content provider;
provide a prompt for additional information related to the content; and
receive a response to the prompt.
